(19) United States
(12) Patent Application Publication
(10) Pub. No.: US 2025/0134091 A1
(43) Pub. Date: May 1, 2025

(54) Bird Collision Prevention Device and Method

(71) Applicant: O'KEEFFE'S, INC., BRISBANE, CA (US)

(72) Inventor: William F O'Keeffe, Brisbane, CA (US)

(73) Assignee: O'KEEFFE'S, INC., BRISBANE, CA (US)

(21) Appl. No.: 18/934,869

(22) Filed: Nov. 1, 2024

Related U.S. Application Data
(60) Provisional application No. 63/546,836, filed on Nov. 1, 2023.

(51) Int. Cl. A01M 29/32; A01M 29/10; A01M 29/16

(52) U.S. Cl. CPC A01M 29/32; A01M 29/10; A01M 29/16

(57) ABSTRACT

A device and method for protecting a window or other apparatus or location from birds or other pests. The device utilizes lights, motion, and/or sounds to chase away the pests once the pests are detected. For example, birds approaching a window can be detected and the device using light, sound, and/or motion to chase the birds off to avoid a collision with the window.

The disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCES TO RELATED APPLICATIONS

This application claims the benefit of U.S. provisional patent application Ser. No. 63/546,836 filed on Nov. 1, 2023, incorporated herein by reference.

### BACKGROUND

Birds are very active animals that can fly at high speed, which means that collisions with flying birds can harm the birds and anything that the bird collides with. Also, roosting birds can cause harm by their nest making and waste products. In particular, birds have been known to fly into windows with tragic consequences to the bird, and sometimes the windows. A system for preventing one or more of these problems is desired.

### SUMMARY

Provided are a plurality of embodiments of devices and/or treatments that can be utilized to warn birds or other pests away from dangerous locations where the pests can be harmed and/or important devices damaged.

Also provided is a method of discouraging pests comprising the steps of: providing an active deterrent system configured to chase the pests away from a protected location; detecting the presence of the pests; and activating the active deterrent system when the pests are detected.

Further provided is a method of discouraging birds from colliding with a window comprising the steps of: providing an active deterrent system configured to chase the birds away from a window location; detecting the presence of the birds near or approaching the window; and activating the active deterrent system when the birds are detected.

Still further provided is a method of discouraging birds from colliding with a window comprising the steps of: providing an active deterrent system configured to chase the birds away from a window location, said active deterrent system including flashing lights; installing said active deterrent system on or at an already installed window; detecting the presence of the birds near or approaching the window; and activating the active deterrent system when the birds are detected.

Also provided is a system for performing the above methods, with that system including a deterrent system to deter the pests and a detection system for detecting the pests.

Further provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a schematic of a first example bird collision prevention window embodiment;

FIG. 2 is a schematic of a first example bird collision prevention installation device;

FIG. 3 is a schematic of a second example bird collision prevention window embodiment;

FIG. 4 is a schematic of a second example bird collision prevention installation device;

FIG. 5 is a schematic of a control and sensor system to support the bird collision prevention window systems; and

FIG. 6 is a schematic of an example bird collision prevention installation device for windmills.

### DETAILED DESCRIPTION OF THE EXAMPLE EMBODIMENTS

Various embodiments of bird collision prevention systems are provided to provide homes and businesses with features that can warn birds away to avoid dangerous or otherwise harmful interactions with flying or roosting birds.

In particular, avoiding bird collisions with windows of various buildings is desired, since such collisions can harm (or even kill) the birds and damage the windows as well.

The example systems described herein can utilize various means of warning or scaring birds away from buildings (or other protected devices or regions), and in particular protect the windows of such buildings. One such means includes flashing lights that warn and confuse the birds and chase them away. Another such means can use sound to scare the birds off. Still other means may use mechanical devices to scare the birds, such as waving a flag or activating a robot predator, or other device that can scare the birds off. Furthermore, any combination of such means can be used to improve the performance of the system.

Although such devices can be installed in a window or window frame before installation in the desired building, the ability to retrofit existing buildings is particularly useful so that existing structures can be protected against bird interactions without replacing their window systems.

Generally, the invention adds visual and/or auditory and/or motion features to a window system or other protected entity to use light, sound, and/or object motion to scare off the birds before they can collide with the protected system.

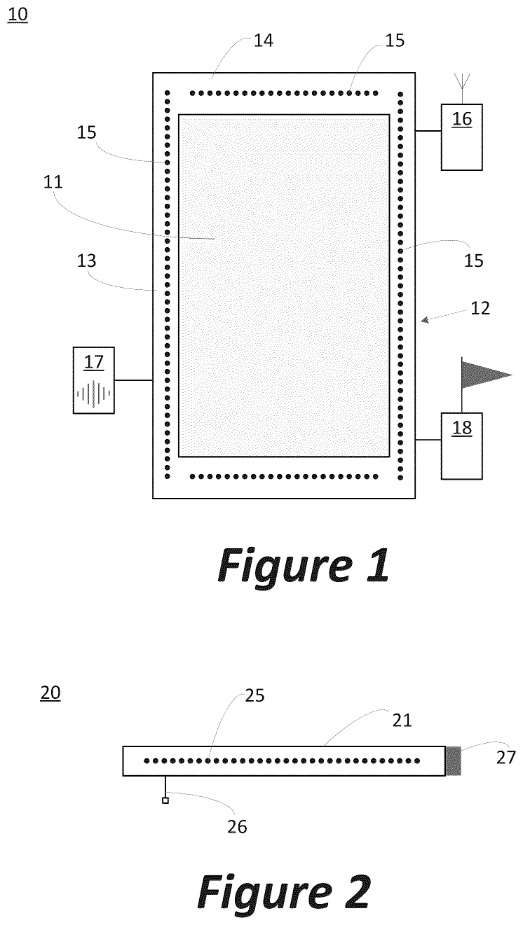

FIG. 1 shows a first example embodiment of a window system 10 that is provided with various bird protection features. A window 11 is provided in a window frame 12, such as in a home or other building. The window frame 12 is provided with horizontal members 14 and vertical members 13 that are provided with various warning devices for scaring the birds away from the window. Such warning devices include flashing lights 15 that can be LED lamps, neon lights, incandescent lights, lasers, or other light sources, for example. Alternatively or additionally, sound speakers 17 or motorized flags 18 or other moving objects could be provided as alternatives or additions to the lights 15. These warning devices 15, 17, and 18 are connected together by a power bus that is connected by a power unit 16 that communicates with a remote control unit (not shown) for activating the scare devices when bird activity is detected.

FIG. 2 shows an example bird collision prevention installation device 20 that has a plurality of warning devices 25, such as LED or other light sources, provided on an attachable strip 21 that can include wiring connected to a proper voltage source for powering the lights. A connector 26 is provided so that an internal power bus that provides power to the devices 25 can be connected to a power and control source. Alternatively, the device 20 can be provided with battery power. Such a strip can be applied to a window frame, such as shown in FIG. 1, by using an adhesive backing or some other types of fasteners to mount the device 20 on an existing window frame.

The device 20 might have an antenna and controller 27 integrated therein to provide a connection to a control system, such as via WiFi, cellular, RF, or other means to control the device. Alternatively, the device 20 might have a bird detection sensor incorporated with the controller 27 to act as a self-contained bird scaring device not requiring external control. Furthermore, the device 20 can add sound and/or motion devices as described herein to further scare the birds.

The device 20 may be a very thin, flexible strip, such as of a polymer, that may have the warning devices 25, such as thin LED lamps, embedded therein with a transparent covering. An adhesive can be provided on the strip for ease of installation, or mounting hardware can be provided. This strip may be flexible, lightweight, weatherproof, and easily applied to existing window frames on an exterior of the windows to be retrofitted to existing structures. Alternatively, the device 20 can be comprised of a rigid construction. The device 20 could be powered by a replaceable, rechargeable, or permanent battery attached thereto or integrated therewith.

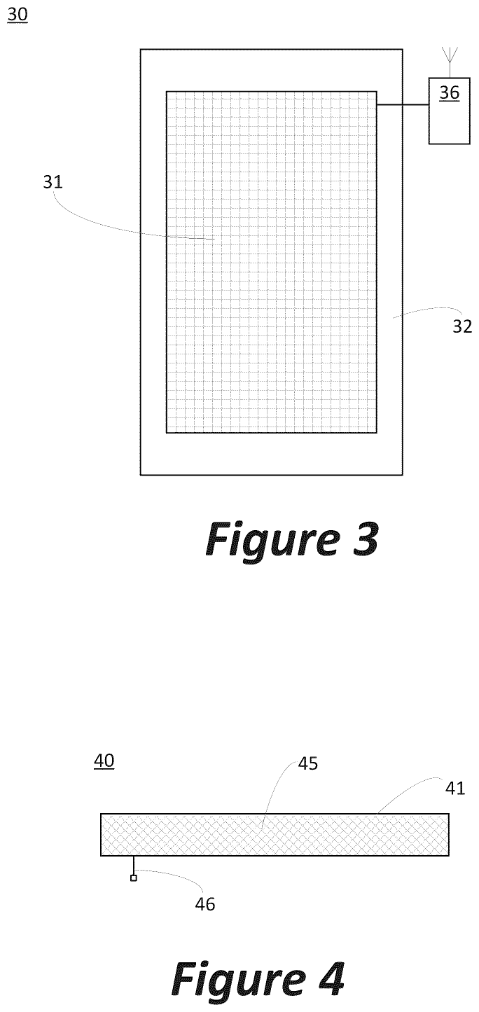

FIG. 3 shows another example embodiment of a window system 30 that is provided with bird protection features. In this system, the warning devices are integrated into the window 31, such as by embedding them into the window glass itself, or as a film applied on top of the window glass. In a laminated glass window, the warning devices can be embedded in one of the layers of the laminate, or provided as an additional layer of the laminate. The warning devices could be comprised of very thin light-emitting threads or films, small LED lamps, or electrically activated phosphorescent or other light emitting materials that can be provided continuously across or throughout the glass. Such a film can be comprised of high voltage, low amperage tape or film encompassing both LED or other lights and a supply voltage that can interface with the detection system.

Alternatively, the warning devices might be of an LCD or electronic ink or some other material that makes the glass appear opaque to remove the illusion that the bird can fly through the window.

The warning devices of the window 30 are connected together by a power bus or web that is connected by a power unit 36 that communicates with a remote control unit (not shown) for activating the scare devices when bird activity is detected. Alternatively, the window 30 could be self-contained with a bird detecting sensor and controller embedded therein or attached thereto.

FIG. 4 shows a device 40 as another example device that can be applied to window frames or directly to windows, which may be comprised as a very thin strip that may have the warning devices 45 as described for the window system 30 such that the warning devices are uniformly incorporated throughout the strip 41 and connected to an external power system by the connector 46. This strip may be flexible, lightweight, weatherproof, and easily applied to existing window frames on an exterior of the windows. Instead of a strip, this device 40 could be provided as film sheets that can be applied directly to windows. Alternatively, the device 40 could be self-contained with a bird detecting sensor and controller embedded therein or attached thereto. The device 40 could be powered by a replaceable, rechargeable, or permanent battery attached thereto or integrated therewith.

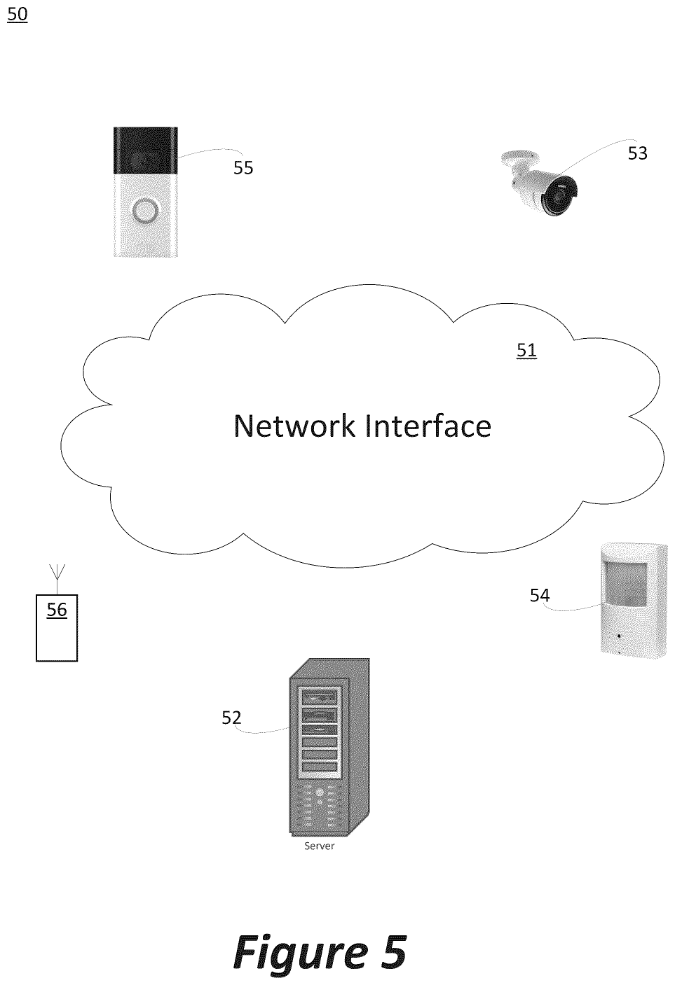

FIG. 5 shows an example control system for controlling the various window systems described above. A computer server 52, or alternatively an embedded processor, can be programmed to receive the inputs from various sensors, such as video cameras 53, motion sensors 54, and vendor provided systems line the ring doorbell system 55, all connected via a cloud or WiFi network 51 to the computer 52. The system might use infrared sensors to detect the living birds. The system will then communicate with the window systems either via the network 51, or by a dedicated radio or wired communication device 56 or embedded communications systems as discussed herein.

Note that this computer server system 52 might be provided locally (such as part of a security system), or it could be provided remotely at some centralized location serving multiple locations simultaneously, as a truly cloud based system. The control/computer system can be integrated in to a burglar or other smart system located at the protected location, such as an alarm system, a smart speaker system (e.g., Amazon's Echo, Apple's HomePod, Sonos, Nest, or other smart system), a local monitoring system such as a video or doorbell system (e.g., Amazon's Ring) or other networked system. The system can be configured to notify the homeowner or another interested party of its activation and use.

The basic operation of any of the above systems is as follows:

A central computer system or programmed processor monitors the inputs from one or more sensors to detect bird or other animal activity, such as birds congregating or flying around the vicinity of the protected building, squirrels congregating about, racoons, skunks, etc.. Such sensors can visually detect birds (or other animals), or detect bird (or other animal) motion, or even detect bird sounds, for example. The system will be programmed to analyze this sensor data, perhaps using artificial intelligence routines, to determine when there is a risk that bird activity could include birds flying into the protected windows or other animal pests congregating about. If such a risk is determined to be likely, the system can activate the various warning devices for the appropriate windows (i.e., where the risk of bird collisions is greatest).

These warning can include flashing warning devices that flash lights at a rate, and at frequencies (both in flashing time and in light color) that are most effective in scaring or otherwise chasing the birds (or other animal pests) away. Such frequencies might be dependent on the species of the animal, which might be determined by expert systems executing on the server system.

In addition or alternatively, speakers may be used to emit sounds to scare the birds, such as the vocalizations of predators or irritating frequencies. Possibly, sound frequencies outside the range of human hearing could be used.

In addition or alternatively, devices may be used to turn the windows opaque to deter the birds.

In addition or alternatively, mechanical devices could be activated, such as motion flags or robotic predator decoys to scare off the birds.

In this manner, the system detects a risk of birds flying into windows, or other pests congregating about, and actuates preventative measures to try to avoid such collisions or congregation from occurring.

Note that beyond window usage, such treatments could be provided to other locations or devices where avoiding interaction with birds is desired.

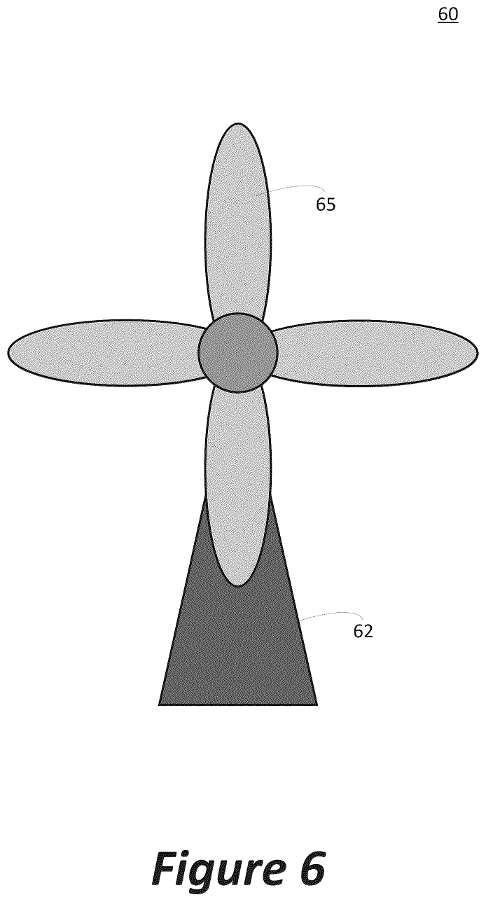

For example, windmills (wind turbines) used for generating electricity might have their wind vanes or other parts of the windmills treated similarly in order to chase off birds to avoid deadly interactions with the windmills. FIG. 6 shows a simplified sketch of a windmill 60 having a tower 62 and vanes 65. The vanes can be comprised of a laminated material including warning lights embedded in a layer of a laminate, similar to as described for the window of FIG. 3. Alternatively, the lights can be added as an external layer, such as described hereinabove for the window of FIG. 1 or 3. Sound or motion devices, as discussed hereinabove, can also be utilized.

Another potential use could be that solar energy farms might use such features to keep birds from being harmed by solar concentrators, for example. In such situations, devices similar to those used for the windows can be applied to chase off birds. Additional uses where animal pests need to be scared off can also utilize these devices and methods.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of discouraging pests comprising the steps of:
providing an active deterrent system configured to chase the pests away from a protected location;
detecting the presence of the pests; and
activating the active deterrent system when the pests are detected.

2. The method of claim 1, wherein said active deterrent system includes flashing lights.

3. The method of claim 1, wherein said active deterrent system includes broadcasting a noise.

4. The method of claim 1, wherein said active deterrent system includes moving an object.

5. The method of claim 1, wherein said active deterrent system is configured for installation on or art an already installed window.

6. The method of claim 1, wherein said pests are birds.

7. The method of claim 1, wherein said detecting step utilizes a sensor located remotely from the protected location.

8. The method of claim 1, wherein said system is configured to interact with a local network.

9. The method of claim 8, wherein said local network includes a smart speaker system, monitoring system, and/or alarm system.

10. The method of claim 1, wherein said system is configured to protect a windmill.

11. A method of discouraging birds from colliding with a window comprising the steps of:
providing an active deterrent system configured to chase the birds away from a window location;
detecting the presence of the birds near or approaching the window; and
activating the active deterrent system when the birds are detected.

12. The method of claim 11, wherein said active deterrent system includes flashing lights.

13. The method of claim 11, wherein said active deterrent system includes broadcasting a noise.

14. The method of claim 11, wherein said active deterrent system includes moving an object.

15. The method of claim 11, wherein said detecting step utilizes a sensor located remotely from the protected location.

16. The method of claim 11, wherein said system is configured to interact with a local network.

17. The method of claim 16, wherein said local network includes a smart speaker system, monitoring system, and/or alarm system.

18. A method of discouraging birds from colliding with a window comprising the steps of:
providing an active deterrent system configured to chase the birds away from a window location, said active deterrent system including flashing lights;
installing said active deterrent system on or at an already installed window;
detecting the presence of the birds near or approaching the window; and
activating the active deterrent system when the birds are detected.

19. The method of claim 18, wherein said active deterrent system also includes broadcasting a noise.

20. The method of claim 11, wherein said system is configured to interact with a local network.

21. The method of claim 20, wherein said local network includes a smart speaker system, monitoring system, and/or alarm system.
